(19) United States
(12) Patent Application Publication
(10) Pub. No.: US 2011/0043848 A1
(43) Pub. Date: Feb. 24, 2011

(54) METHOD FOR IMPLEMENTING RESOURCE CONSERVATION POLICIES WITH PRINTING DEVICES

(76) Inventors: Jayasimha Nuggehalli, Cupertino, CA (US); Seong Kim, Saratoga, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/544,705

(22) Filed: Aug. 20, 2009

(51) Int. Cl. G06F 15/00

(52) U.S. Cl. 358/1.15

(57) ABSTRACT

A method and apparatus for policy based enforcement of print job attributes is provided. A printing device receives a print job that includes user identification information. The printing device determines a policy associated with the user identification information. The policy indicates how electronic documents associated with that user are to be printed. A command, based on the policy, is inserted into the print job. The command includes at least one of: a) a duplex command; b) a grayscale command; c) an N-up command; or d) a command reducing the use of consumable resources at the printing device.

### FIELD OF THE INVENTION

The present invention relates to print job filtering, and specifically relates to policy based implementation of print job attributes.

### BACKGROUND

Printers, copy machines, and multi-function peripheral (MFP) devices provide valuable functionality that is frequently used in the workplace, public institutions, and the home. Users often print documents by pressing a button in an application, which causes the document that is currently open in the application to be printed using “default” settings. For example, the printer configuration on the user's system may be configured to print on only one side of each page, in color, using the highest quality available.

These default settings are sometimes configured by a network administrator. For example, a network administrator may configure the printer driver to print in duplex so that each side of each piece of paper is utilized. However, these settings can be easily modified by the user, making enforcement of a desired configuration difficult.

Because of convenience considerations, users tend to choose a set of configuration options they find acceptable, and leave those settings in place indefinitely. Users who fail to consider the environmental and monetary costs of the resources they are using tend to be less conservative in their configuration choices. For example, users tend to enjoy printing even draft documents using the highest quality setting available. These users and are often undeterred by the additional time required to print a document in high quality.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

Techniques are provided for policy based enforcement of print job attributes. In one embodiment, a printing device has communications control logic configured to receive a print job that includes user identification information. The printing device also has policy management logic, which is configured to determine a particular policy, among a plurality of policies. The policy is associated with the user identification information, and also indicates how electronic documents associated with that user are to be printed. The policy management logic is further configured to insert a command into the print job. The command is based on the particular policy and includes at least one of: a) a duplex command; b) a grayscale command; c) an N-up command; or d) a command reducing the use of consumable resources at the printing device.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram illustrating an example network on which an embodiment of the invention may be implemented.

FIG. 2 is a diagram illustrating an example network on which an embodiment of the invention may be implemented.

FIG. 3 is a block diagram illustrating an embodiment of a printing device on which the invention may be implemented.

FIG. 4 is a diagram illustrating a policy table used in an embodiment.

FIG. 5 is a flow diagram representing a logical decision making process performed by an embodiment of the invention.

FIG. 6 is a control flow diagram representing a logical decision making process performed by an embodiment of the invention.

FIG. 7 illustrates a computer system on which an embodiment may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

In one embodiment, a printing device has communications control logic configured to receive a print job that includes user identification information. The printing device also has policy management logic, which is configured to determine a particular policy, among a plurality of policies. The policy is associated with the user identification information, and also indicates how electronic documents associated with that user are to be printed. The policy management logic is further configured to insert a command into the print job. The command is based on the particular policy and includes at least one of: a) a duplex command; b) a grayscale command; c) an N-up command; or d) a command reducing the use of consumable resources at the printing device. In one embodiment, the inserted command supersedes a command in the first print job. The printing device also includes printing logic configured to physically alter the appearance of a material based on the print job.

Other embodiments include logic configured to retrieve the particular policy from a server over a communications network. Other embodiments include logic configured to retrieve the particular policy from a local table stored on the printing device and to update the local table based on global policy information, comprising a plurality of policies, received from a server. Other embodiments include administrator interface logic configured to generate a graphical user interface for specifying policy information, receiving policy information, and updating a local table to include the policy information. Other embodiments include user notification logic configured to determine a user, based at least in part on user identification information, and send a policy notification to the user indicating the particular manner used to process the print job. In other embodiments, the printing device is a print server that sends the print job to a second printing device for printing.

### Structural and Functional Overview

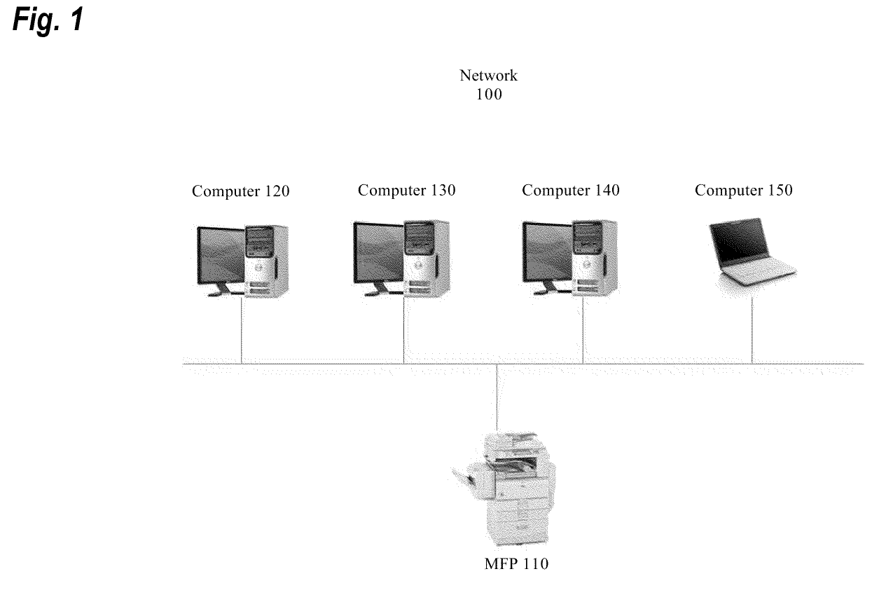

FIG. 1 is a diagram illustrating an example network 100 on which an embodiment may be implemented. Computers 120-150 and MFP 110 are each communicatively connected to network 100. Alternatively, a computer 120 may be connected directly to a printing device such as MFP 110. The present invention is not limited to any particular networking protocol or networking hardware. The number of computers 120-150 may vary depending on implementation, and need not be limited. Although embodiments are depicted in the figures and described herein in the context of computers, the approach is applicable to other types of network devices.

Computers 120-150 may send print jobs to MFP 110, instructing MFP 110 to perform a print operation. For example, a user using computer 120 may be viewing a document, and wish to print the document. When the user selects an option to print the document, computer 120 creates a print job and sends the print job to MFP 110. The document may be printed on paper or any other media, and may even be printed to another document such as a Portable Document Format (PDF) document.

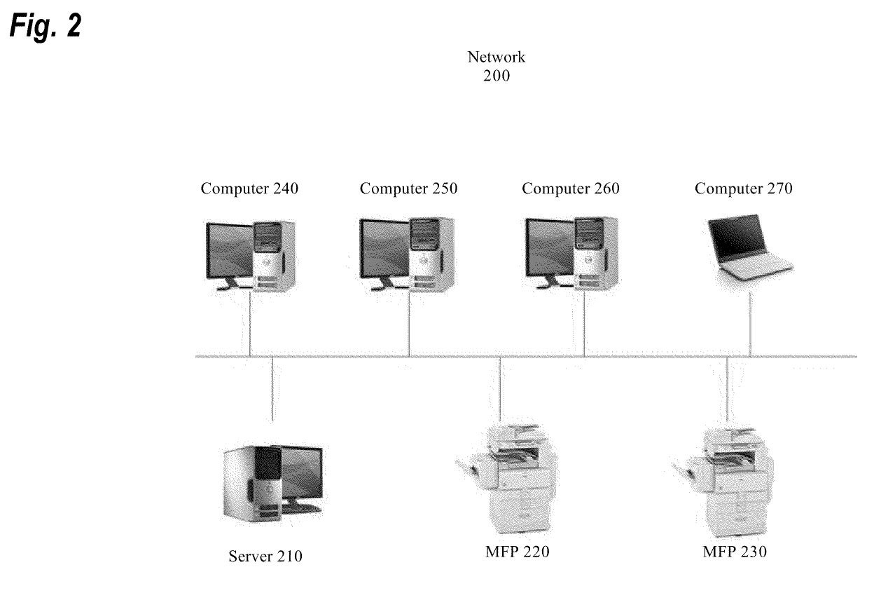

FIG. 2 is a diagram illustrating another example network 200 on which an embodiment of the invention may be implemented. Computers 240-270, server 210, and MFPs 220 and 230 are each communicatively connected to network 200. MFP 220 and MFP 230 are each capable of communication with server 210. Server 210 need not be connected to network 100 as shown, as long as server 210 is capable of communication with MFP 220 and MFP 230. For example, server 210, MFP 220, and MFP 230 may each be connected via a network other than network 200 so that server 210 is not exposed to computers 240-270.

Computers 240-270 may send print jobs to MFP 220 and MFP 230 via network 200 or any other communication means. MFP 220 and 230 request printing policy information from server 210.

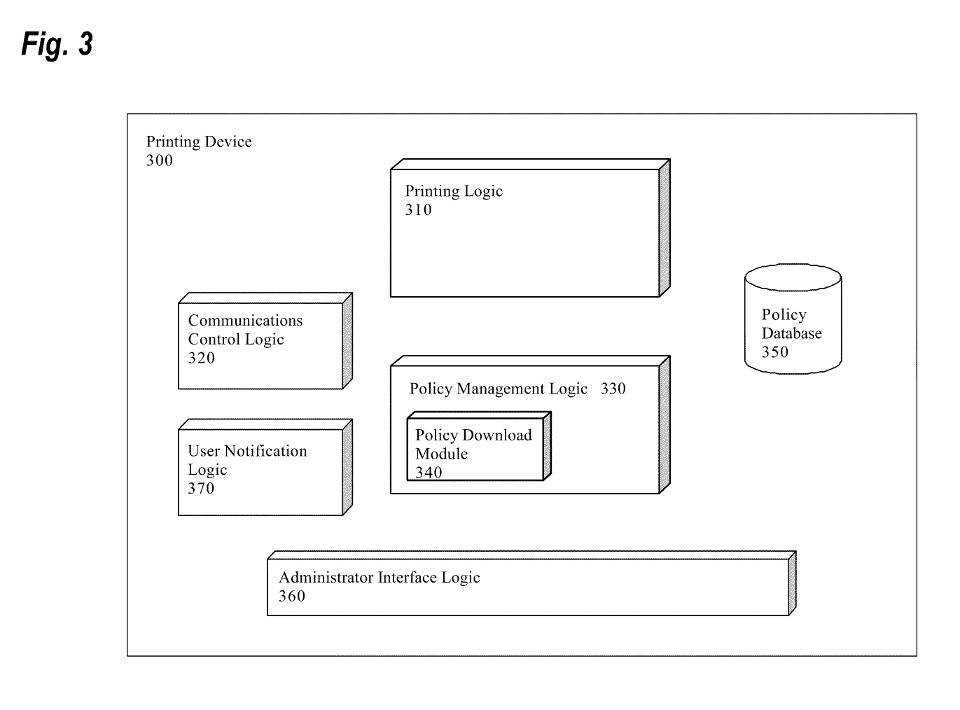

FIG. 3 is a block diagram illustrating an embodiment of a printing device 300 on which the invention may be implemented. A printing device may be a printer, print server, or any other device configured to handle printing information, such as a general purpose computer, router, or switch that is configured as a print server.

Printing device 300 includes printing logic 310, communications control logic 320, policy management logic 330, policy download module 340, policy database 350, administrator interface logic 360, and user notification logic 370. Additional components may exist within printing device 300. For example, in the interest of clarity, a processor and memory are included in printing device 300, but are not shown. Also, some elements of printing device 300 are optional, and others may be implemented as part of another element or outside of printing device 300. For example, user notification logic 370 is optional, administrator interface logic 360 may be implemented as part of policy management logic 330, and policy database 350 may be implemented externally. In addition, printing device 300 may comprise more than one policy download module 340 to facilitate implementation of a distributed policy management architecture.

Printing logic 310 performs core printing and interpretation functions. Printing logic 310 receives, as input, a print job with instructions that describe the manner in which a document should be printed. Communications control logic 320 handles communications functions. Communications control logic 320 includes at least one communications interface, and logic required to interpret network-based communications.

Policy management logic 330 receives, as input, a print job, and parses the print job in order to determine the manner in which a document is to be printed, as specified in the print job. Policy management logic 330 receives this input from printing logic 310, or from communications control logic 320, depending on the implementation of the embodiment. Policy management logic 330 may intercept a print job destined for printing logic 310 and alter the print job. Alternatively, printing logic 310 may forward the print job to policy management logic 330. Policy management logic 330 will then alter the print job and return the altered version of the print job to printing logic 310.

Policy download module 340, in an embodiment, downloads policy data from a server such as server 210. Policy data is then stored in policy database 350. Policy management logic 330 alters incoming intercepted print jobs based on policies stored in policy database 350.

Administrator interface logic 360, in an embodiment, provides a web-based interface that allows an administrator to define policies that are stored in the policy database 350. In another embodiment, administrator interface logic provides an interface that is not web-based, such as a command-line interface. In another embodiment, administrator interface logic provides an interface to configure policy management logic 330 and policy download module 340. In other embodiments, administrator interface logic 360 is capable of providing an interface for configuring any portion of the printing device 300. Policy database 350 may be controlled and synchronized by administrator interface logic 360. In another embodiment, synchronization operations are performed by a synchronization module, which may be separate from, or integrated into an existing component of the printing device 300, such as policy management logic 330.

### Printing Policies

In computing, policies are used to ensure a desired outcome in a particular given situation. Conflicting policies may be resolved by additional policies, a policy hierarchy, or by structure, such as determining which policy was applied first. In an embodiment, one or more policies are used to determine the manner in which documents are processed by a printing device 300.

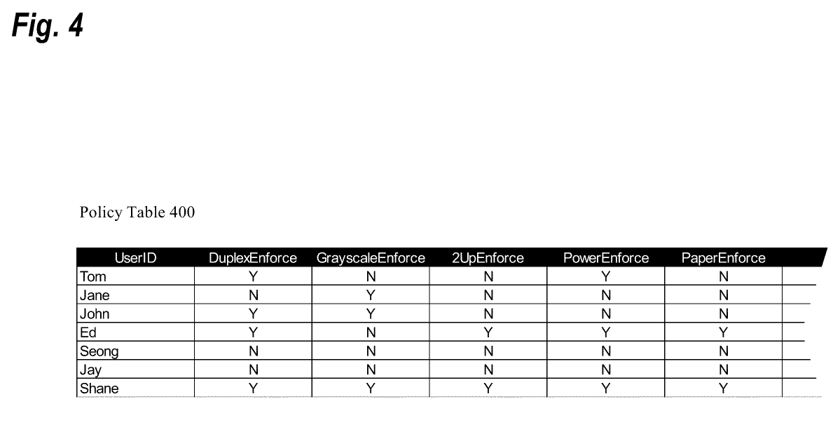

FIG. 4 is a diagram illustrating a policy table 400 used in an embodiment. In other embodiments, additional policy enforcement items may be used. For example, a subset of the policy enforcement items may be used. In one such embodiment, only duplex and grayscale policies are enforced. A printing device 300 is configured to receive a print job, and enforce policy decisions based on policy table 400.

For example, a print job may be received for Tom, a user associated with a set of policies in policy table 400. Policy table 400 associates the user “Tom” with two enforced policy items: DuplexEnforce and PowerEnforce. This means that Tom is required to print using the duplex option, or dual-sided printing. In addition, Tom is required to print using power-saving options available to the printer.

Policies may be used by an administrator to achieve organizational, environmental, or other goals. For example, it may be an organizational goal to reduce the use of consumable resources, such as paper, ink, and electricity. Other consumable resources may include replacement parts associated with maintenance of printing devices, or any other media type used in a printing operation, such as printable DVD-ROMs and plastics.

Policy table 400 shows the following five example policy enforcement items: DuplexEnforce, GrayscaleEnforce, 2UpEnforce, PowerEnforce, and PaperEnforce. The policy enforcement items that may be used in conjunction with the approach described herein are not restricted to these examples.

DuplexEnforce ensures that the user associated with the policy prints in duplex. A user with this policy item enabled, as indicated by the “Y” in the DuplexEnforce column, will always print on both sides of a page instead of only one side of a page. This option reduces the amount of paper used by about 50%.

GrayscaleEnforce enforces the printing of documents in grayscale. The grayscale option ensures that printed documents are composed exclusively of shades of gray, varying in intensity. Black has the weakest intensity while white has the strongest. If a user makes a request to print a document, and the GrayscaleEnforce policy item is enabled, then the document will be printed in grayscale. This is so, even if the user requests that the document be printed in color. Printing in color is more expensive, and uses additional toner. Enabling the GrayscaleEnforce option reduces the amount of consumable resources used, as well as the cost of the consumable resources used.

2UpEnforce is a policy item that, when enabled, ensures that two pages of a document are printed on one side of a page. For example, a document may be two pages long. When 2UpEnforce is enabled, both pages of the document will print on a single side of a page. This option provides a “shrinking” effect, resulting in the use of less paper. When combined with DuplexEnforce, a four page document may be printed on a single sheet of paper by printing two pages on each side of the single piece of paper. This option is commonly referred to as N-Up, where N is a variable representing the number of pages to be printed on a single side of a piece of paper. For example, the N-Up option may be configured as 4-Up, where four pages are printed on a single side of a piece of paper. Although 2-Up is used in an embodiment, all N-Up features may be used by the invention.

PowerEnforce, when enabled, ensures that energy efficient methods of printing are used when available. In some printing devices, such options may require more time to print, or result in a finished product with lower-than-optimal resolution.

PaperEnforce ensures the use of a particular paper size, paper tray, or paper type. A user may attempt to circumvent the effects of the 2UpEnforce option by directing the printer to print from a tray having double-sized paper, thereby cancelling the resource usage reduction effects of the policy. By requiring that a user print to a particular type of paper, the effects of other policies are measurable.

Additional options may be configured for each feature discussed. For example, if DuplexEnforce is enabled, then 2UpEnforce may be configured to be enforced only when more than two pages are being printed. This is because only one piece of paper would be used, even if the 2UpEnforce policy item is enforced. Although printing both pages of the two-page document on one side of the piece of paper may require less toner than printing full-scale pages in duplex, an administrator may make a quality judgment about the resulting product, determining that the additional toner usage is acceptable in this scenario.

Other options that are not discussed herein will also work with the present invention. For example, a printing device 300 may have the ability to print using only one color (monochrome), or print using a low quality setting in an effort to save toner. In the interest of clarity, some of these features are left out of the specification. In addition, it is expected that new options for reducing the use of resources will be made available by printing device manufacturers. The present invention is forward-compatible, and may be used to enforce policies associated with any new resource-saving option made available.

Policies may reside on the printing device 300 in a table, such as policy table 400. The policy table 400 may reside in policy database 350.

In an embodiment, policy data may reside in a database on a centrally located server, such as server 210. A policy download module 340 may download global policy information from server 210 and store the global policy information in policy database 350. Policy download module 340 may be configured to download policy information at administrator-specified time intervals. Alternatively, policy download module 340 may request updated policy data for a specific user each time a print job is received for that user.

In another embodiment, policy download module downloads policy data from server 210 when local policy data for a user is older than a configurable policy expiration time value. Policy data is cached in policy database 350, along with a time stamp that indicates when the policy data was known to be accurate. This reduces the load on the server, and allows for efficient local policy verification when updates are not necessary.

In one embodiment, policy information is stored and retrieved in Extensible Markup Language (XML). Below is an example implementation of policy data in XML format.

```
<?xml version=″1.0″>
<policy>
  <user>
    <id>Tom</id>
    < DuplexEnforce >Y</ DuplexEnforce >
    < GrayscaleEnforce >N</ GrayscaleEnforce >
    < 2UpEnforce >N</ 2Up Enforce >
    < PowerEnforce >Y</ PowerEnforce >
    < PaperEnforce >N</ PaperEnforce >
  </user>
  <user>
    <id>Jane</id>
    < DuplexEnforce >N</ DuplexEnforce >
    < GrayscaleEnforce >Y</ GrayscaleEnforce >
    < 2UpEnforce >N</ 2Up Enforce >
    < PowerEnforce >N</ PowerEnforce >
    < PaperEnforce >N</ PaperEnforce >
  </user>
  <user>
    <id>John</id>
    < DuplexEnforce >Y</ DuplexEnforce >
    < GrayscaleEnforce >Y</ GrayscaleEnforce >
    < 2UpEnforce >N</ 2Up Enforce >
    < PowerEnforce >N</ PowerEnforce >
    < PaperEnforce >N</ PaperEnforce >
  </user>
  <user>
    <id>Ed</id>
    < DuplexEnforce >Y</ DuplexEnforce >
    < GrayscaleEnforce >N</ GrayscaleEnforce >
    < 2UpEnforce >Y</ 2Up Enforce >
    < PowerEnforce >Y</ PowerEnforce >
    < PaperEnforce >Y</ PaperEnforce >
  </user>
  <user>
    <id>Seong</id>
    < DuplexEnforce >N</ DuplexEnforce >
    < GrayscaleEnforce >N</ GrayscaleEnforce >
    < 2UpEnforce >N</ 2Up Enforce >
    < PowerEnforce >N</ PowerEnforce >
    < PaperEnforce >N</ PaperEnforce >
  </user>
  <user>
    <id>Jay</id>
    < DuplexEnforce >N</ DuplexEnforce >
    < GrayscaleEnforce >N</ GrayscaleEnforce >
    < 2UpEnforce >N</ 2Up Enforce >
    < PowerEnforce >N</ PowerEnforce >
    < PaperEnforce >N</ PaperEnforce >
  </user>
  <user>
    <id>Shane</id>
    < DuplexEnforce >Y</ DuplexEnforce >
    < GrayscaleEnforce >Y</ GrayscaleEnforce >
    < 2UpEnforce >Y</ 2Up Enforce >
    < PowerEnforce >Y</ PowerEnforce >
    < PaperEnforce >Y</ PaperEnforce >
  </user>
</policy>
```

The above XML file represents the policy data found in policy table 400. An administrator may upload the XML policy file to the printing device via administrator interface logic 360.

An administrator may also upload, via administrator interface logic 360, a comma separated value (CSV file) that contains policy information. In an embodiment, a CSV file containing policy information, or a CSV policy file, may conform to the following example:

UserID,DuplexEnforce,GrayscaleEnforce,2UpEnforce,
PowerEnforce,PaperEnforce
Tom,Y,N,N,Y,N
Jane,N,Y,N,N,N
John,Y,Y,N,N,N
Ed,Y,N,Y,Y,Y
Seong,N,N,N,N,N
Jay,N,N,N,N,N
Shane,Y,Y,Y,Y,Y

An administrator may also manually enter policy data on a per-user basis via a web interface provided by administrator interface logic 360. For example, a hypertext markup language (HTML) form containing policy enforcement options may be presented to the administrator. When the administrator submits the form, administrator interface logic processes the form and adds the policy data to policy database 350.

### Enforcing Policy Decisions

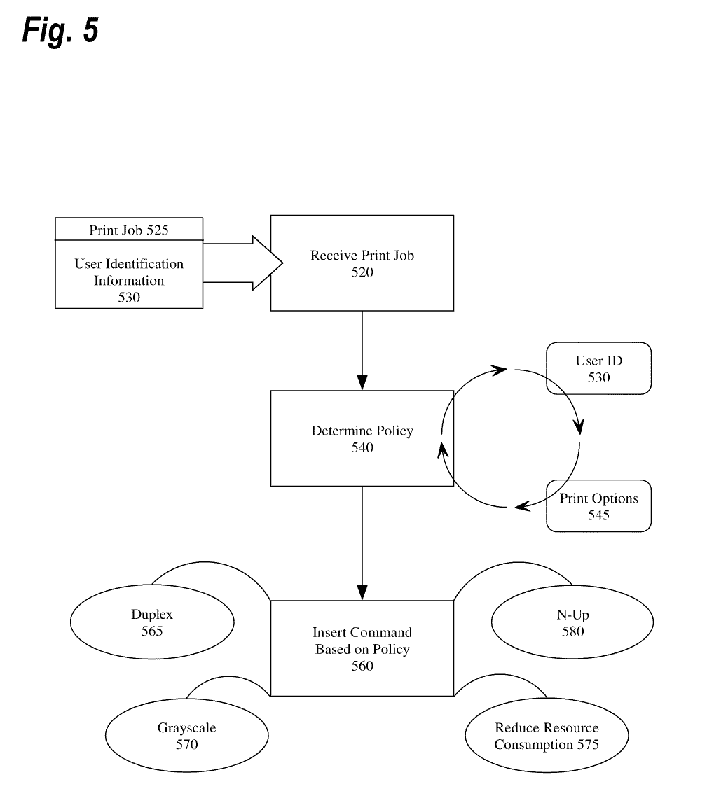

The flow diagram of FIG. 5 provides a high-level overview of the policy enforcement model used in an embodiment. At step 520, a print job 525 is received. Print job 525 contains user identification information 530. At step 540, a policy is determined based on user identification information 530, which is associated with print options 545. This step may be accomplished, for example, by performing a table lookup in policy table 400. At step 560, a command is inserted into the print job based on the policy determined in step 540. For example, one or more of a duplex command 565, grayscale command 570, N-Up command 580, or another command that reduces resource consumption 575 may be inserted into the print job 525.

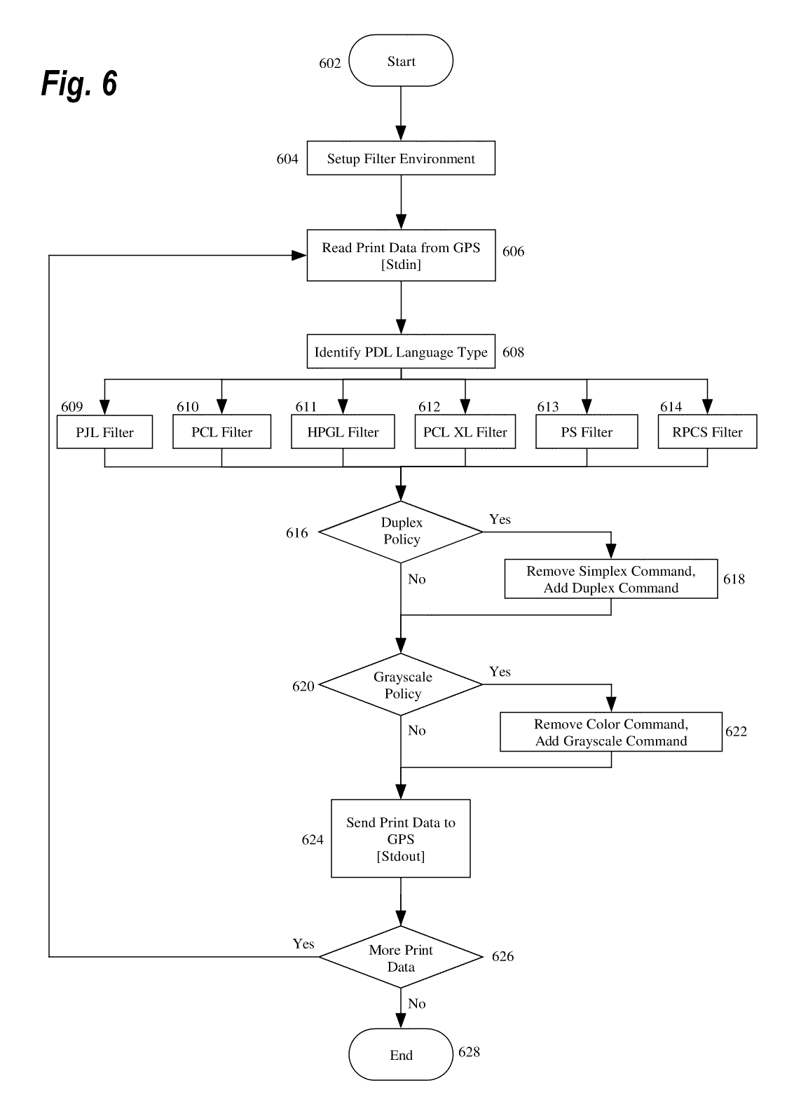

FIG. 6 represents a detailed control flow diagram illustrating policy enforcement in an embodiment, beginning at step 602. At step 604, the printing device 300 sets up a filter environment. The filter environment, or policy management logic 330 is initialized to intercept incoming print jobs and alter the print jobs according to policy. If no filter environment is initialized, then print jobs will be processed as usual, without policy considerations.

If the filter environment is initialized, printing logic 310 allows pre-processing of the print job to be performed by policy management logic 330. At step 606, policy management logic 330 reads print data from printing logic 310, also known as the GW Print System (GPS). At step 608, a page description language (PDL) type used by the print data is identified. If (PJL) is used, then the data is directed to the PJL filter 609. If printer control language (PCL) is used, then the data is directed to the PCL filter 610. If Hewlett-Packard graphics language (HPGL) is used, then the data is directed to the HPGL filter 611. If printer control language 6 (PCL XL) is used, then the data is directed to the PCL XL filter 612. If PostScript (PS) is used, then the data is directed to the PS filter 613. If the Ricoh Refined Printing Command Stream (RPCS) is used, then the data is directed to the RPCS filter 614. A filter for any other language may be implemented in an embodiment.

Each filter performs parsing and insertion of print commands. Multiple languages may be used in a print job. For example, a PJL header may be included in a print job with PS or PCL data. As a result of parsing the print job stream, user identifying information is determined from a job header in a PJL command. The filter checks against to policy table 400 to identify the policy that has been configured for the user. FIG. 6, for simplicity, is based on the assumption that the only available policies are a duplex policy and grayscale policy. Other policies may be used in the manner disclosed herein.

At step 616, the filter 609-614 determines whether there is a duplex policy for the user. If so, at step 618, a simplex command is removed, and a duplex command is added. If not, the flow continues. At step 620, the filter 609-614 determines whether there is a grayscale policy in place for the user. If so, a color command is removed, and a grayscale command is added. At step 624, print data is sent to the GPS, or printing logic 310.

At step 626, policy management logic 330 determines whether there is more print data. If so, the flow returns to step 606. If not, the flow ends at step 628.

In an embodiment, commands are not removed, but instead are only added. For example, at step 618, a duplex command is inserted after a simplex command. The duplex command will take precedence because the duplex command is inserted after the simplex command. In an embodiment, printing logic 310 may cause the simplex command to be executed, and then cause the duplex command to be executed. The subsequent duplex command overrides the simplex command by providing a new value for the option that was previously set by the simplex command. In an embodiment, printing logic 310 may ignore the simplex command. The document will print in duplex.

### Example Commands

The following table provides PJL commands for simplex and duplex options:

| Mode | Command |
|---|---|
| Simplex | @PJL SET DUPLEX=OFF |
| Duplex | @PJL SET DUPLEX=ON |
| | @PJL SET BINDING=LONGEDGE |

The following table provides example PJL commands for color and grayscale options:

| Mode | Command |
|---|---|
| Color | @PJL SET RENDERMODE=COLOR |
| Monochrome[Grayscale] | @PJL SET RENDERMODE=GRAYSCALE |

The following table provides example PJL commands for N-UP options:

| Mode | Command |
|---|---|
| NUP | @PJL SET NUP=2 |
| | @PJL SET NUPPAGEORDER=RIGHTTHENDOWN |

The following table provides example PJL commands for toner saving options:

| Mode | Command |
|---|---|
| TONERSAVER | @PJL SET ECONOMODE=ON |
| | @PJL SET ECONOMODE=OFF |

The commands above are not meant to be an exhaustive list of commands, but are intended to provide examples of commands that may be used in an embodiment. Some commands are hardware specific. In addition, many PDLs exist, and each PDL may have various commands that differ from those discussed herein. The PDLs discussed herein are meant to serve as examples, and not limitations, since any PDL may be used in an embodiment.

### User Notification of Policy Enforcement

Users for whom a policy has recently been implemented may not notice the change in the way documents are printing. This is particularly true for users who interact with electronic copies of documents, and print documents only for review and proof-reading. However, users for whom a more aggressive policy profile has been configured may immediately notice the change. For example, a user with a policy profile enforcing 2-Up, duplex, and grayscale options that requests that a document be printed in high-quality color, 1-Up, using single-sided printing will quickly become aware of the change. These users may mistakenly assume that incorrect driver settings caused the document to print in an unexpected manner.

In an embodiment, users are notified when a policy has been enforced on a print job originating from that user. User notification logic 370 is communicatively coupled to policy management logic 330. When policy management logic 330 enforces a policy, policy management logic 330 passes user identification information 530 to user notification logic 370. User identification information 530 may include an email address, network user name, computer name, or any other information that may be used to notify the user. User notification logic 370 may use any user identification information 530 to cross-reference with other available information to gain more notification options. For example, if the user identification information comes from a table such as policy table 400, and contains no email address, the UserID is used by the user notification logic to find an email address associated with the user in another database. User notification logic 370 then uses the email address for notification purposes.

Upon learning of a policy enforcement event and receiving user identification information 530, user notification logic 370 notifies the user for which a policy was enforced that there has been a change in the way the document is being processed by the printing device 300. The notification may take place before or after, or even while the print job is being modified. The user may be notified by email or by a network command that creates a dialog box on the user's computer. Alternatively, user notification logic 370 may instruct printing logic 310 to print a page immediately before the document is printed, known as a “flag” that notifies the user of changes to the print job. Other methods of notification that rely on user identification information 530 may also be used.

The notification message may be as detailed or as complicated as the administrator wishes. For example, a message may state that the print job has been altered according to a printing policy, and direct the user to contact the administrator if he has any questions. Alternatively, the message may state that the user is not allowed to print in color, and that the print job has been altered accordingly. Policy identifiers and user identification information may also be part of the notification message.

### Alternative Embodiments

Although this application discusses the processing of print jobs, resulting in printing the document, the present invention may be used to cause a document to be printed in PDF format in a way that conforms to a printing policy. For example, the N-UP setting works with PDF direct printing. Causing a document to be printed to PDF with 2 pages per side ensures that the document, if printed on paper at a later time, will require fewer consumable resources.

### Implementation Mechanisms

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

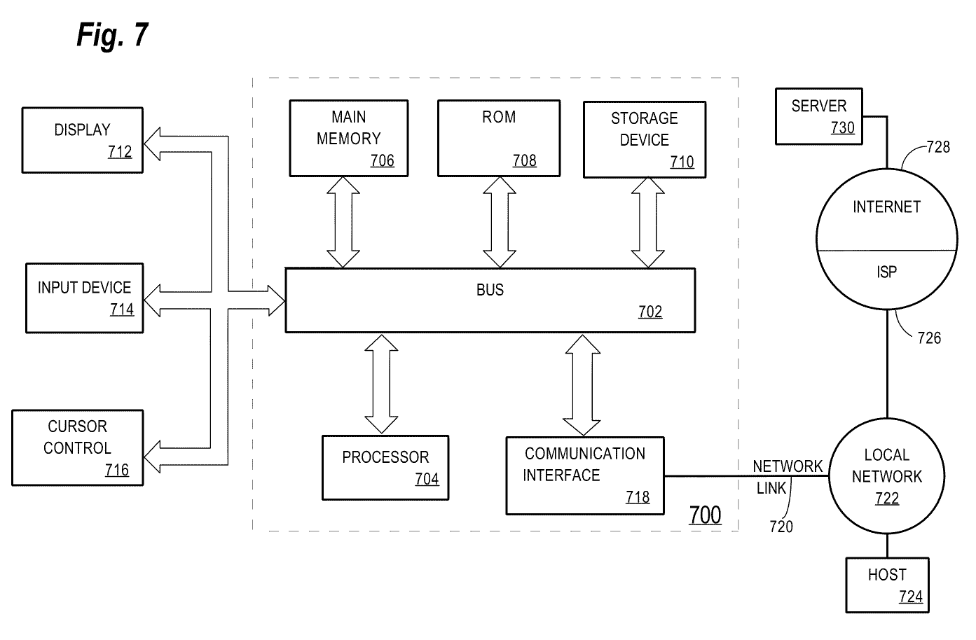

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A printing device, comprising:
communications control logic configured to receive a print job, wherein the print job comprises user identification information;
policy management logic configured to:
determine a particular policy, among a plurality of policies, wherein the particular policy is associated with the user identification information and indicates how electronic documents associated with that user are to be printed;
insert a command into the print job to create a modified print job, wherein the command is based on the particular policy and comprises at least one of:
a) a duplex command;
b) a grayscale command;
c) an N-up command; or
d) a command reducing the use of consumable resources at the printing device;
printing logic configured to physically alter the appearance of a material based on the modified print job.

2. The printing device of claim 1, wherein the policy management logic is further configured to retrieve the particular policy from a server over a communications network.

3. The printing device of claim 1, wherein the policy management logic is further configured to retrieve the particular policy from a local table stored on the printing device.

4. The printing device of claim 3, wherein the policy management logic is further configured to update the local table based on global policy information received from a server, wherein the global policy information comprises the plurality of policies.

5. The printing device of claim 3, further comprising:
administrator interface logic configured to:
generate a graphical user interface for specifying policy information;
receive policy information;
update the local table to include the policy information.

6. The printing device of claim 1, further comprising:
user notification logic configured to:
determine a user, based at least in part on user identification information;
send a policy notification to the user indicating the particular manner used to process the print job.

7. A computer-implemented method of enforcing printing policies, comprising:
receiving a print job, wherein the print job comprises user identification information;
determining a particular policy, among a plurality of policies, wherein the particular policy is associated with the user identification information and indicates how electronic documents associated with that user are to be printed;
inserting a command into the print job to create a modified print job, wherein the command is based on the policy;
wherein the method is performed by one or more computing devices.

8. The method of claim 7, wherein the command comprises at least one of:
a) a duplex command;
b) a grayscale command;
c) an N-up command; or
d) a command reducing the use of consumable resources at a printing device.

9. The method of claim 7, wherein the inserted command supersedes a command in the print job.

10. The method of claim 7, further comprising, in response to inserting the command into the print job to create a modified print job, forwarding the modified print job to a printing device.

11. The method of claim 7, further comprising retrieving the particular policy from a server over a communications network.

12. The method of claim 7, further comprising retrieving the particular policy from a local table stored on the one or more computing devices.

13. The method of claim 12, further comprising updating the local table based on global policy information received from a server, wherein the global policy information comprises the plurality of policies.

14. A computer-readable storage medium storing instructions for enforcing printing policies, which instructions, when executed by one or more processors, cause the one or more processors to perform the steps of:
receiving a print job, wherein the print job comprises user identification information;
determining a particular policy, among a plurality of policies, wherein the particular policy is associated with the user identification information and indicates how electronic documents associated with that user are to be printed;
inserting a command into the print job to create a modified print job, wherein the command is based on the policy.

15. The computer-readable storage medium of claim 14, wherein the command comprises at least one of:
a) a duplex command;
b) a grayscale command;
c) an N-up command; or
d) a command reducing the use of consumable resources at a printing device.

16. The computer-readable storage medium of claim 14, wherein the inserted command supersedes a command in the print job.

17. The computer-readable storage medium of claim 14, further comprising instructions for, in response to inserting the command into the print job to create a modified print job, forwarding the modified print job to a printing device.

18. The computer-readable storage medium of claim 14, further comprising instructions for retrieving the particular policy from a server over a communications network.

19. The computer-readable storage medium of claim 14, further comprising instructions for retrieving the particular policy from a local table.

20. The computer-readable storage medium of claim 19, further comprising updating the local table based on global policy information received from a server, wherein the global policy information comprises the plurality of policies.
